(19) United States
(12) Patent Application Publication
(10) Pub. No.: US 2017/0132685 A1
(43) Pub. Date: May 11, 2017

(54) MONETIZING SEARCH RESULTS AS AN ELECTRONIC MARKETPLACE

(71) Applicant: Merry Houston Hou, Menlo Park, CA (US)

(72) Inventor: Merry Houston Hou, Menlo Park, CA (US)

(21) Appl. No.: 15/409,525

(22) Filed: Jan. 18, 2017

Related U.S. Application Data
(60) Provisional application No. 62/280,672, filed on Jan. 19, 2016.

(51) Int. Cl. G06Q 30/06; G06Q 30/04; G06F 17/30

(52) U.S. Cl. CPC G06Q 30/0625; G06F 17/30867; G06Q 30/04

(57) ABSTRACT

The systems and methods for monetizing search results as an electronic marketplace are disclosed. A user is provided with search results from a plurality of website entities in a search result space provided by a search engine site. A user indication, such as hovering over a search result, identifying at least one of the search results from the plurality of website entities is received and in response a single pane having effective contents relating to the website entity is provided. To monetize search results, the search engine site can utilize effective contents via a single pane to facilitate user interaction and/or user purchase of goods and services relating to the website entity. Search engine sites can charge website entities fees for user purchase and/or user input leading to user purchase at a later time, such that is monetizing search results as an electronic marketplace.

### CROSS-REFERENCE TO RELATED APPLICATION

This application claims benefit of U.S. Provisional Application No. 62/280,672, filed Jan. 19, 2016, which is hereby claimed under 35 U.S.C. §119.

### BACKGROUND OF THE INVENTION

1. Field of the Invention

The present invention relates to search results and, more specifically, to monetizing search results as an electronic marketplace.

2. Description of the Related Art

Today, search engine sites for the majority generate revenue by creating programs in advertisement while providing free of fees service to website entities as search results within the search result space. While the advertising programs utilized by search engine sites are successful, there are some drawbacks. By way of example, an ever increasing amounts of mobile technology floods the user market, such as smart phones, these small screen devices make advertisement difficult to display and in turn less effective. By way of another example, some mobile technology makers have created systems and methods allowing users to reduce and/or eliminate advertisement on mobile devices. An increase in user irritation towards advertisement has risen in the digital advertisement marketplace, this in turn creates ineffective advertisement for online merchants. By way of example, a user who searches “blue jeans” within a search engine site may not desire to encounter “blue jeans” advertisement in her email at a later time. By way of another example, a users interacting with a website entity's contents relating to “computers” may not desire experiencing advertisement for “auto insurance” or other unrelated goods/services. The above mentioned are reflections of a ever evolving digital industry demanding new creatives in generating revenue beyond advertisement.

As ever increasing number of people turn to the internet for information and goods/services, search engine sites, specifically the search result spaces are seen by users as a gateway towards finding and navigating towards website entities for information and goods/services. The two most common practices are search result links and/or advertisement links displayed on a search result space. Both are designed to provide a user the quickest way of finding and navigating towards the website entities based on their search query, and in turn navigating quickly away from the search engine site. By only servicing as a gateway, the lack in retaining user navigation within the search engine site limits new revenue opportunities.

Many search engine sites facilitate their own somewhat popular online payment system, in turn generate revenue from its services. The drawback, the millions of website entities who provide goods and services are delivered to a user in the form of search results by a search engine site. These website entities for the majority are not yet linked easily and fully within a network of online payment systems. Although users have multiple payment options when entering search query in the interest of a purchase, the user must for the most part manually enter a payment credit card at the end of a purchase. This lack of universal payment system limits revenue generation from a search engine's online payment system.

Some search engine sites are providing block previews based on user search queries within the search result space. By way of example, the search query “paris flights” generates in some search engine sites present brief summaries of city departure and arrival, dates of flights and a handful of pricing options within a block preview. The drawbacks are two fold. First, a sponsored tag indicates this service is only provided by those website entities who has paid for this block preview as an advertisement, limiting the search engine's revenue only from advertisement. Second, although the user interface of a single block preview of goods and service is now common practice amongst the web, the search engine sites have neglected it's most useful aspect. The user's ability to browse, select goods and services, in turn make a final purchase all within one single block preview without leaving the original search result space. The search query example of “paris flights”, as of today, demands another half dozen screens before completion of one paris flight purchase order. This user interface of a single purchase order requiring multiple screens becomes antiquated practice for these search engine sites.

In order to optimizing revenue for search engine sites the drawbacks described above calls for a need in creating new arts to monetizing search engine sites.

### BRIEF SUMMARY OF THE INVENTION

The systems and methods described herein may be new art for search engine sites expressed in any electronic device. The monetization of search results as an electronic marketplace can provide new market opportunities for search engine sites. According to one aspect, to monetize search results, the search engine site can utilize, as an example, effective contents via a single pane to facilitate user interaction and/or purchase of goods and services. The monetization of search results can also utilize, as an example, effective contents via a single pane to facilitate user information input to facilitate user interaction and/or user purchase at a later time. According to another aspect, search engine sites can offer for free to website entities for set up and/or registration of effective content single panes associated with the contents of the website entity. The search engine sites can also offer for free to website entities for user hover, impressions, clicks and/or such user interaction which does not lead to an immediate user purchase. According to another aspect, search engine sites can charge website entities fees for user purchase via the effective content single pane and/or charge a fee for user input leading to user purchases at a later time, such that it is monetizing search results as an electronic marketplace. By way of example, search engine sites can provide tools for free to a website entity in the form of a social network site to facilitate a user's personalized effective content within the single pane, such as a landing page, the single pane with personalized effective content can allow a user to navigate, view and post on social networking sites without leaving the search engine site. By way of another example, search engine sites can provide tools for free to a website entity in the form of an insurance merchant to facility the creation of a user information form within the single pane along with personalized effective content. This allowing a user to provide user information input for a chargeable fee while generating non-advertisement revenue, by requesting an insurance quote from the insurance merchant without leaving the search engine site. By way of another example, search engine sites can provide tools for free to a website entity in the form of a media merchant to facility the creation of a subscription form, the single pane with effective content can allow a user to provide user information input for a chargeable fee while generating non-advertisement revenue, by filling out a subscription form from the media merchant without leaving the search engine site. By way of another example, search engine sites can provide tools for free to a website entity in the form of a blog to facility the creation of a signup form, the single pane with personalized effective content can allow a user to provide user information input for a chargeable fee, generating non-advertisement revenue, in requesting new email notices from the blog without leaving the search engine site. By way of another example, search engine sites can provide tools for free to a website entity in the form of a airline merchant to facility the creation of a ticket order form, the single pane with personalized effective content can allow a user to provide user information input for a chargeable fee, generating non-advertisement revenue to purchase airline tickets from the airline merchant without leaving the search engine site.

The monetization of search results as an electronic marketplace can also utilize the effective content single pane as opportunities in optimize revenue for it's own online payment system. By way of example, search engine sites can provide tools to large website entities, such as an airline merchant to facilitate the creation of a airline ticket order, the single pane with personalized effective content can allow a user to purchase tickets from the airline merchant. The online payment system facilitated by the search engine site can utilize the opportunity to charge a fee, there by increasing online payment system marketshare.

### BRIEF DESCRIPTION OF THE DRAWINGS

FIGS. 1A, 1B and 1C are block diagrams of an example of a system for monetizing search results.

FIGS. 2A, 2B and 2C are block diagrams of an example of a system for monetizing search results.

FIG. 3 is a flow chart of an example of a method for monetizing search results.

FIG. 4 is a flow chart of an example of a method for monetizing search results.

FIG. 5 is a flow chart of an example of a method for monetizing search results.

FIG. 6 is an illustrated example of a search result space as an electronic marketplace.

FIG. 7 is an illustrated example of a search result space as an electronic marketplace.

FIG. 8 is an illustrated example of a search result space as an electronic marketplace.

### DETAILED DESCRIPTION OF THE INVENTION

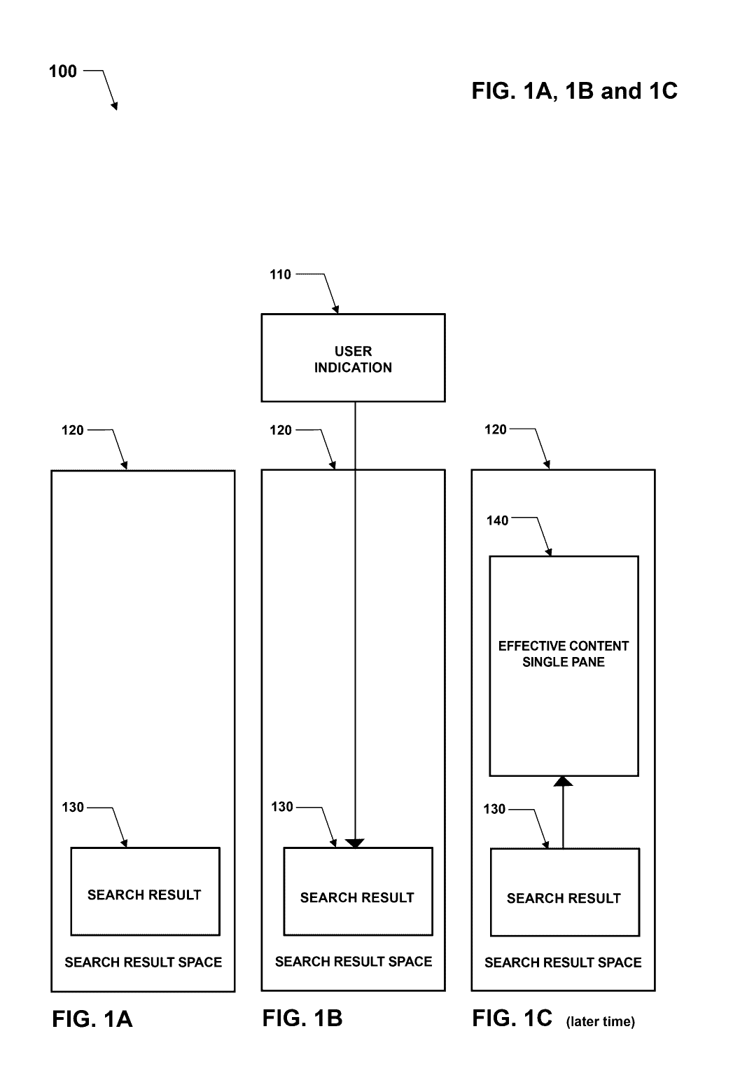

FIGS. 1A, 1B and 10 are block diagrams of an example of a system 100 for monetizing search results 130 as an electronic marketplace by way of effective content single panes 140 activated by user indication 110 with a website entity in the form of a search result 130 shown at different times within a search result space 120. Website entity as used herein refer to any entity presented in a search result space as a search result. The user indication 110 can be explicit actions such as hovering, clicking, information input via keyboard and/or mouse and/or microphone and/or any other input devices of body movement, thought process, gaze direction and similar can be used as input. The User indication 110 can also be implicit actions such as neural networks, expert systems and similar. The search result space 120 can be provided by a search engine site. The search engine site can be a website, a search engine site, an application program, an email service, or any other third party site. The search result 130 can receive a user indication 110 and in response, provide an effective content single pane 140. The search result 130 can be of any type including but not limited to visual, textual, graphical, photographic, audio, speed, video, multimedia and the like. The effective content single pane 140 can provide the user information associated with the website entity provided by the website entity. The system herein can be facilitated by the search engine site. The information associated can be but is not limited to preview navigation, audio content, video content, multimedia content, partially filled-in purchase orders, purchase orders, subscriptions orders, price quote requests.

By way of example, search engine sites can provide tools for free to a website entity in the form of a social network site to facilitate a user's personalized effective content within the single pane, such as a landing page, the single pane with personalized effective content can allow a user to navigate, view and post on social networking sites without leaving the search engine site. By way of another example, search engine sites can provide tools for free to a website entity in the form of an insurance merchant to facility the creation of a user information form within the single pane along with personalized effective content. This allowing a user to provide user information input for a chargeable fee while generating non-advertisement revenue, by requesting an insurance quote from the insurance merchant without leaving the search engine site. By way of another example, search engine sites can provide tools for free to a website entity in the form of a media merchant to facility the creation of a subscription form, the single pane with effective content can allow a user to provide user information input for a chargeable fee while generating non-advertisement revenue, by filling out a subscription form from the media merchant without leaving the search engine site. By way of another example, search engine sites can provide tools for free to a website entity in the form of a blog to facility the creation of a signup form, the single pane with personalized effective content can allow a user to provide user information input for a chargeable fee, generating non-advertisement revenue, in requesting new email notices from the blog without leaving the search engine site. By way of another example, search engine sites can provide tools for free to a website entity in the form of a airline merchant to facility the creation of a ticket order form, the single pane with personalized effective content can allow a user to provide user information input for a chargeable fee, generating non-advertisement revenue to purchase airline tickets from the airline merchant without leaving the search engine site.

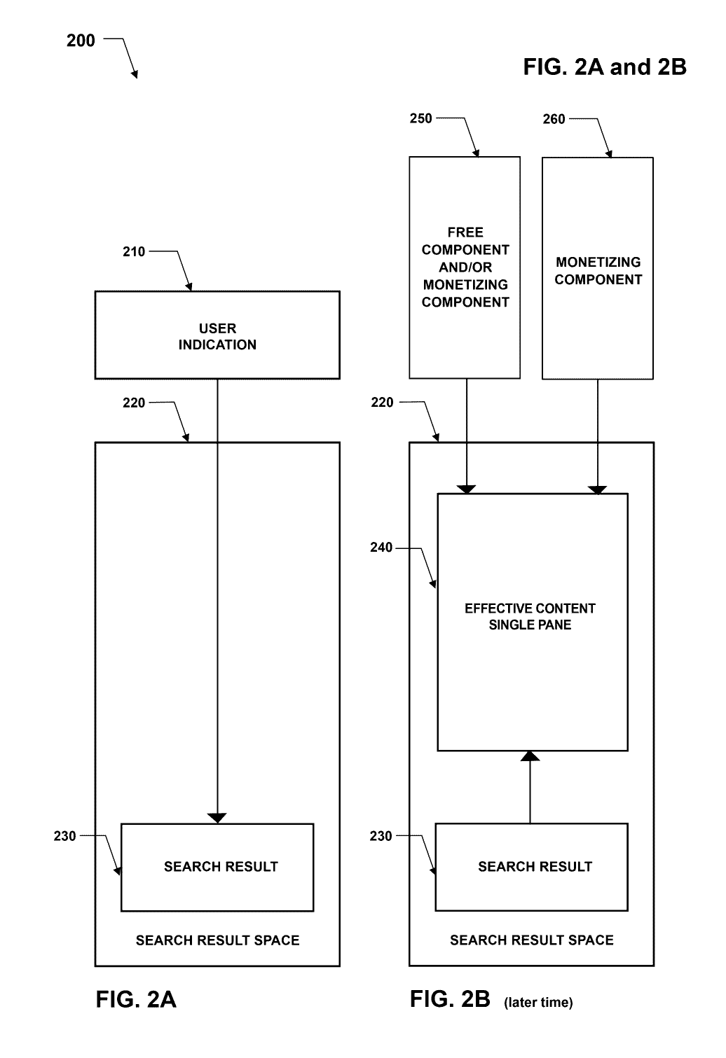

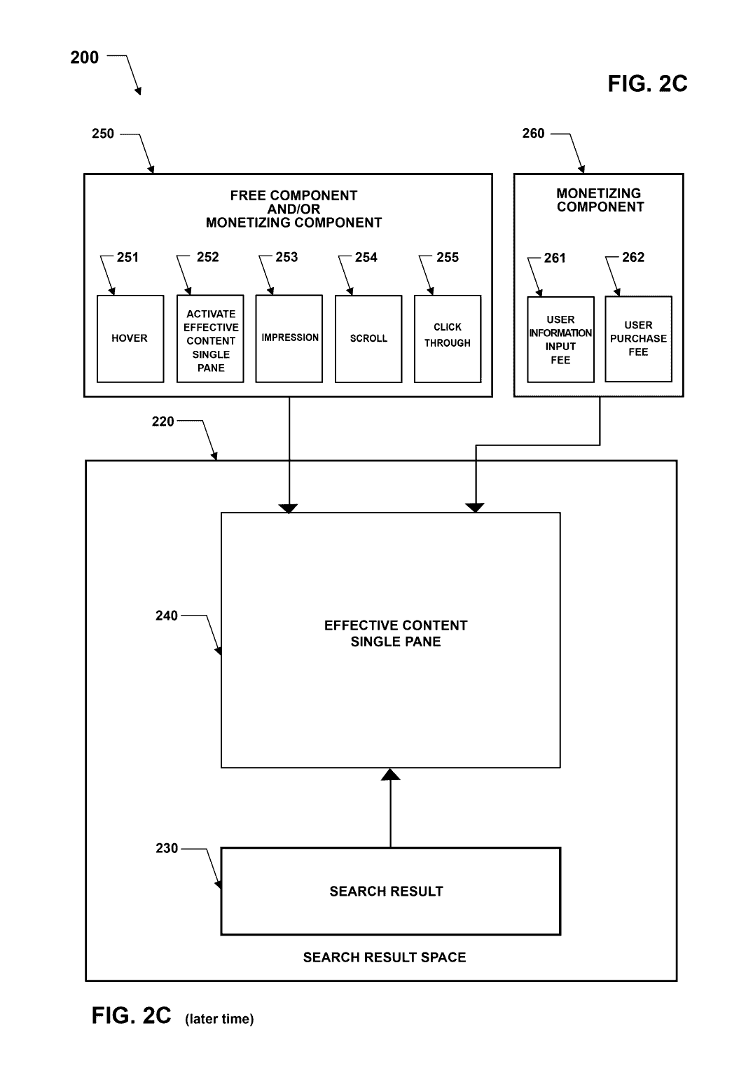

FIGS. 2A, 2B and 2C are block diagrams of an example of a system 200 for monetizing search result 230 as an electronic marketplace by way of effective content single pane 240 activated by user indication 210 shown at an earlier FIG. 2A and at later times FIG. 2B and FIG. 2C. Upon receiving a user indication 210, such as a hover 251 over a search result 230 an effective content single pane 240 is generated. The system 200 also has a free component and/or monetizing component 250 and monetizing component 260.

The system 200 serves to optimize the revenue generated by the search result space 220. According to one aspect, by providing free component 250 facilitating any website entity to utilize this service opens up significant amounts of participants in the search result marketplace and beyond those website entities able to purchase advertising space. According to another aspect, search engine sites can offer to facilitate for free to website entities for set up and/or registration of effective content single panes associated with the contents of the website entity. The search engine sites can also offer for free to website entities for user hover, impressions, clicks and/or such user interaction which does not lead to an immediate user purchase. The system 200 serves to optimize the revenue generated by the search result space 220. According to one aspect, by providing monetizing component 260 facilitating website entities in the form of search results 230 to present goods and services for user purchase within the effective content single pane 240. According to another aspect, the search engine sites can charge website entities fees for user purchase via the effective content single pane and/or charge a fee for user input leading to user purchases at a later time, such that it is monetizing search results as an electronic marketplace. In this system 200, the free component and/or monetizing component 250 and monetizing component 260 utilizes the search result 230 by way of effective content single pane 240 with components of hover 251, activate 252, impression 253, scroll 254, click through 255, user information input 261 and user purchase 262 to optimize the monetizing opportunities of the search result marketplace.

By way of example, the hover 251 can be derived from a user indication 210 of hovering over the search result 230 for a free of charge fee. By way of another example, the click through 255 can be derived from a user clicking on links within the effective content single pane 240 linking to website entity designated landing page for a free of charge fee. By way of another example, the user information input 261 can be derived from a user enlisting to a free email subscription within the effective content single pane 240 for a chargeable fee. By way of another example, the user purchase 262 can be derived from a user purchase order within the effective content single pane 240 for a chargeable fee. Any of the hover 251, activate 252, impression 253, scroll 254, click through 255, user information input 261 and user purchase 262 can be combined with other variables to determine a chargeable fee either for a free of charge fee and/or for a chargeable fee. The system 200 is not limited in the number of levels of effective content it can provide. The fee can be determined by the levels accessed by the user and/or by combinations in whole or in part by one or more of the processes described in relations to FIG. 2A, FIG. 2B and FIG. 2C.

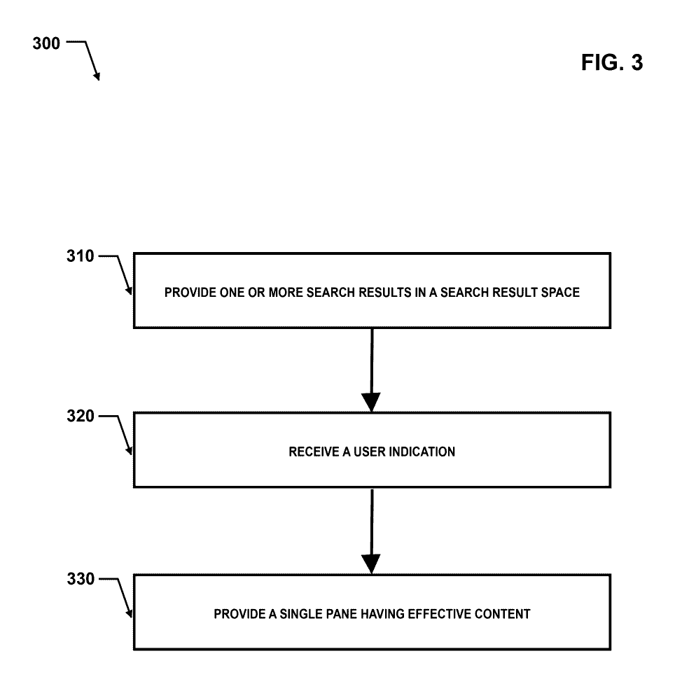

FIG. 3 is a flow chart of an example of a method 300 for monetizing one or more search results in a search result space 310 as an electronic marketplace by way of effective content single pane 330 activated by receiving user indication shown at 320 providing an effective content single pane 330. Upon receiving a user search query, a plurality of website entities in the form of one or more search result 310 are provided in a search result space facilitated by a search engine site. Upon receiving a user indication 320, user interaction with at least one of the search results 310, an effective content single pane 330 is generated, facilitated by the search engine site.

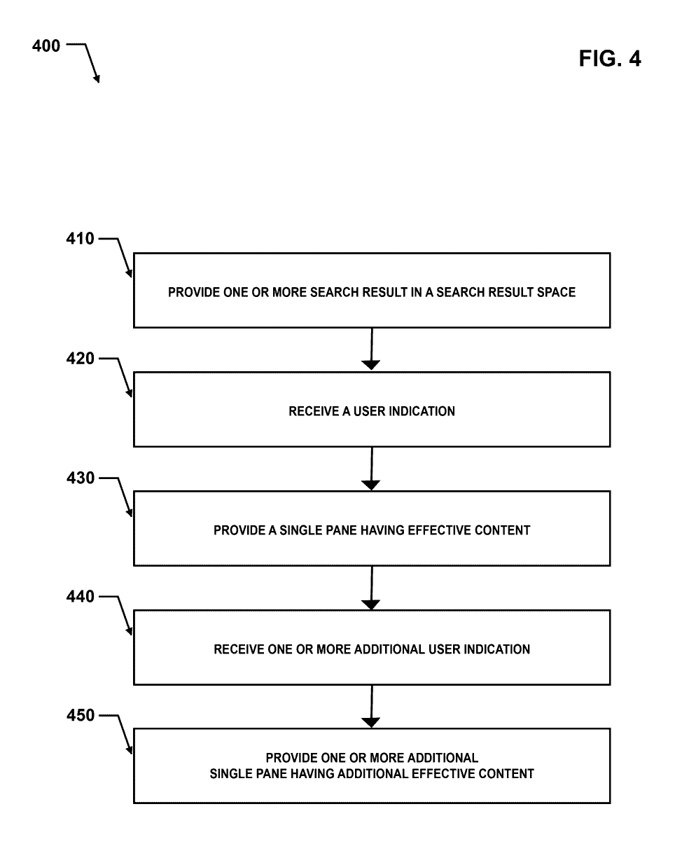

FIG. 4 is another flow chart of another example of a method 400 for monetizing one or more search results in a search result space 410 as an electronic marketplace by way of effective content single pane 430 activated by receiving user indication shown at an earlier 420 and at a later time 440 providing one or more additional effective content single pane 450. Upon receiving a user search query, a plurality of website entities in the form of one or more search result 410 are provided in a search result space facilitated by a search engine site. Upon receiving a user indication 420, user interaction with at least one of the search results 410, an effective content single pane 430 is generated, facilitated by the search engine site. Upon receiving one or more additional user indication 440, one or more additional effective content single panes 450 are generated, facilitated by the search engine site.

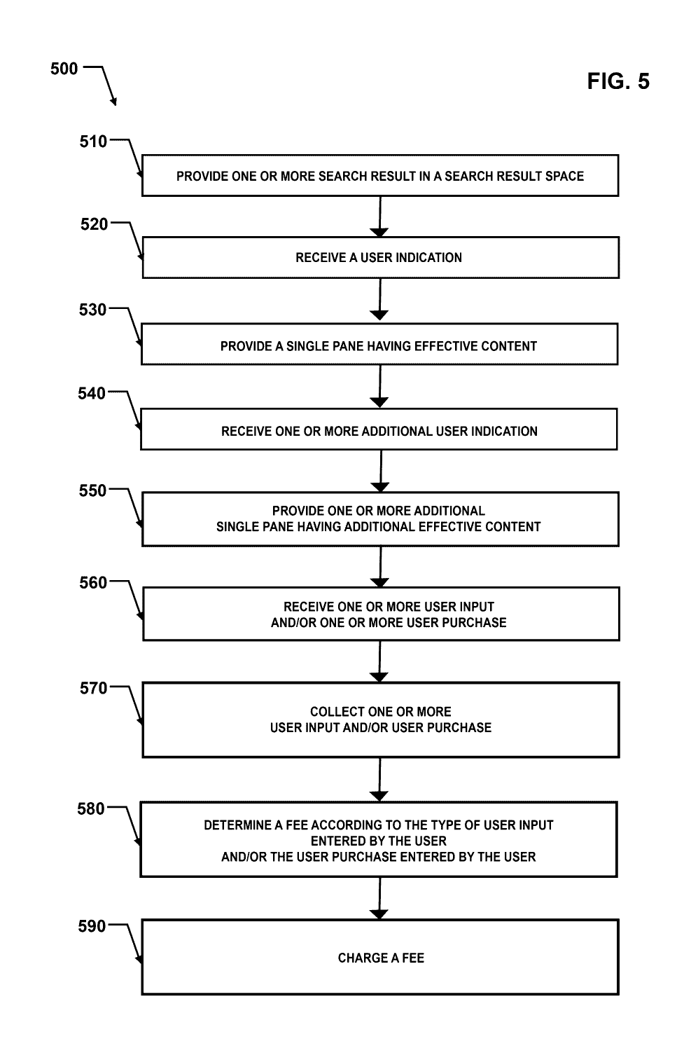

FIG. 5 is another flow chart of another example of a method 500 for monetizing one or more search results in a search result space 510 as an electronic marketplace by way of effective content single pane 530 activated by receiving user indication shown at an earlier 520 and at a later time 540 and/or by receiving user input shown at 560 at a later time. Method 500 collects one or more user input and or user purchase 570, determines a fee according to the type of user input and/or user purchase 580 and charge a fee 590.

Upon receiving a user search query, a plurality of website entities in the form of one or more search result 510 are provided in a search result space facilitated by a search engine site. Upon receiving a user indication 520, user interaction with at least one of the search results 510, an effective content single pane 530 is generated, facilitated by the search engine site. Upon receiving one or more additional user indication 540, one or more additional effective content single panes 550 are generated, facilitated by the search engine site. Upon receiving one or more effective content single pane 530 and/or receiving one or more additional effective content single pane 550, one or more user input and/or one or more user purchase is received 560. Upon receiving one or more user input and/or one or more user purchase 560, the search engine site collects one or more user input and/or user purchase 570. At step 580, the search engine site determines a fee to be charged to the website entity according to the type of user input entered by the user and/or user purchase entered by the user, this can have a free component and/or monetizing component, and/or a monetizing component similar to FIGS. 2A, 2B and 2C.

The method 500 serves to optimize the revenue generated by the search result space. According to one aspect, by providing free component facilitating any website entity to utilize this service opens up significant amounts of participants in the search result marketplace and beyond those website entities able to purchase advertising space. According to another aspect, search engine sites can offer to facilitate for free to website entities for set up and/or registration of effective content single panes associated with the contents of the website entity. The search engine sites can also offer for free to website entities for user hover, impressions, clicks and/or such user interaction which does not lead to an immediate user purchase.

method 500 serves to optimize the revenue generated by the search result space. According to one aspect, by providing monetizing component facilitating website entities in the form of search results to present goods and services for user purchase within the effective content single pane. According to another aspect, the search engine sites can charge website entities fees for user purchase via the effective content single pane and/or charge a fee for user input leading to user purchases at a later time, such that it is monetizing search results as an electronic marketplace.

The free component and/or monetizing component and monetizing component utilizes the search result by way of effective content single pane with components of hover, activate, impression, scroll, click through, user information input and user purchase to optimize the monetizing opportunities of the search result marketplace.

By way of example, the hover can be derived from a user indication of hovering over the search result for a free of charge fee. By way of another example, the click through can be derived from a user clicking on links within the effective content single pane linking to website entity designated landing page for a free of charge fee. By way of another example, the user information input can be derived from a user enlisting to a free email subscription within the effective content single pane for a chargeable fee. By way of another example, the user purchase can be derived from a user purchase order within the effective content single pane for a chargeable fee. Any of the hover, activate, impression, scroll, click through, user information input and user purchase can be combined with other variables to determine a chargeable fee either for a free of charge fee and/or for a chargeable fee.

The method 500 is not limited in the number of levels of effective content it can provide. The fee can be determined by the levels accessed by the user and/or by combinations in whole or in part by one or more of the processes described in relations to FIGS. 2A, 2B and 2C and FIG. 5. Step 580 is not limited to the sequence shown in FIG. 5 and can occur in sub-steps. The determination of fees charged may be determined in whole or in part by one or more of the processes described in relation to FIG. 2A, 2B, 2C and FIG. 5. At step 590, the website entity is charged the fee.

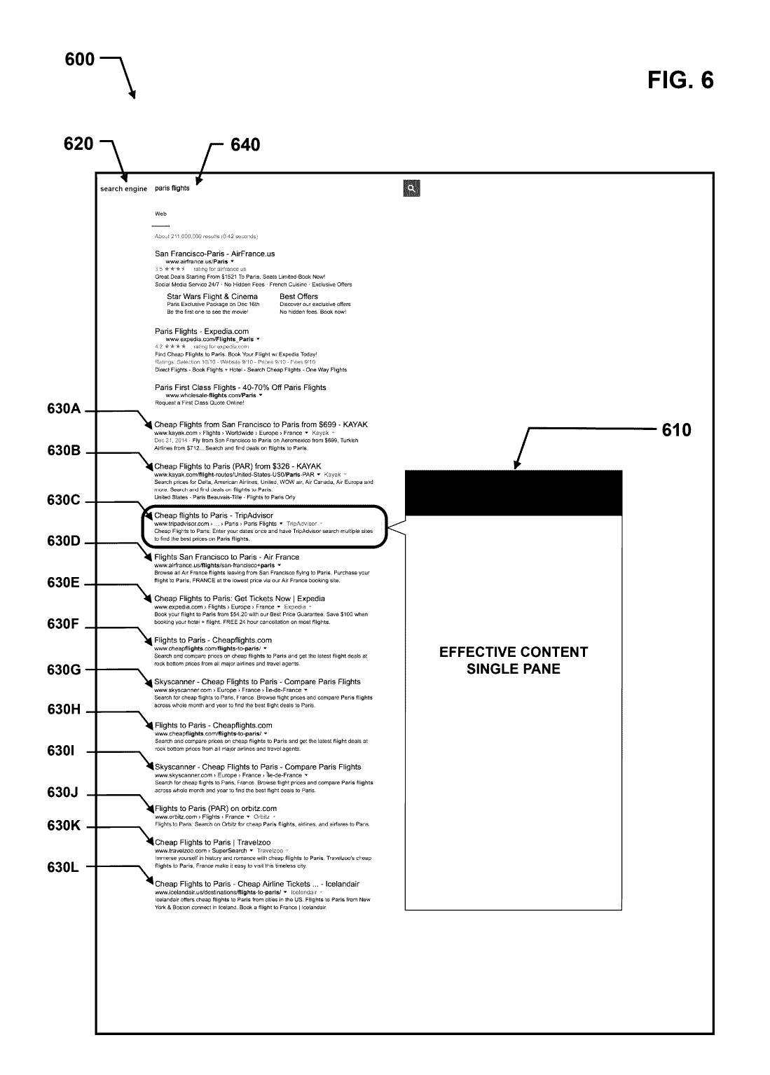

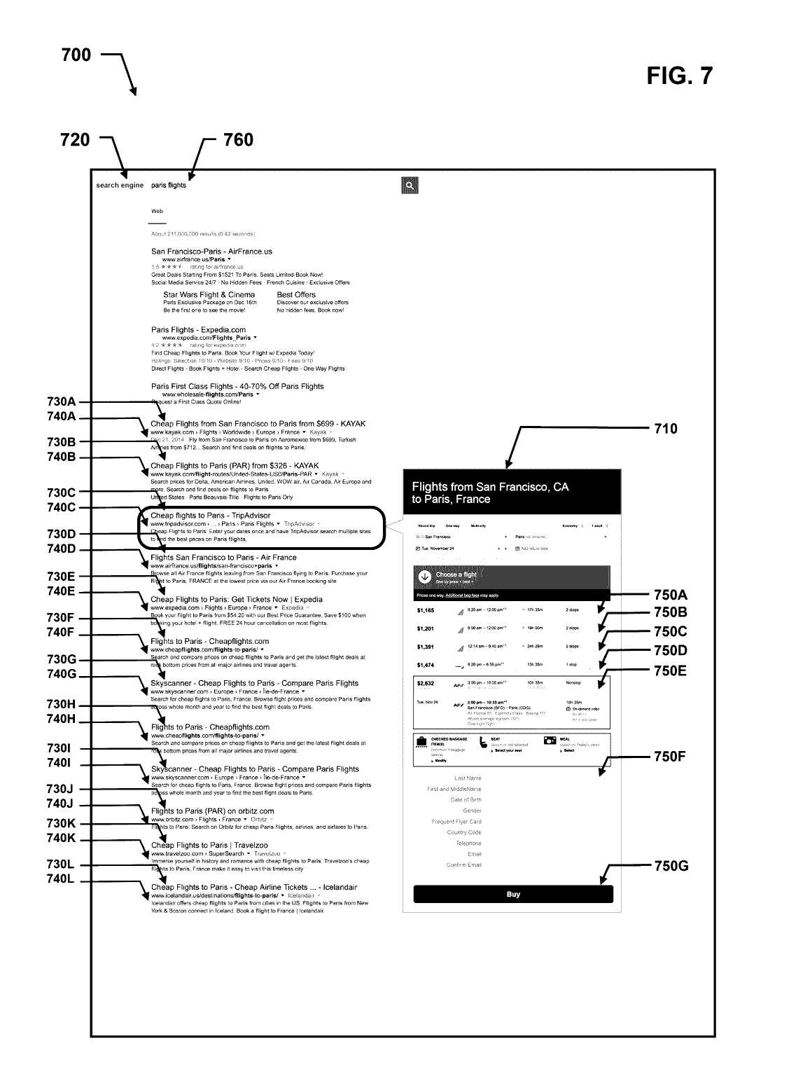

FIG. 6 is an illustrated example of a search result space as an electronic marketplace 600 provided by a search engine site 620. Upon receiving a user search query 640 “paris flights” the search engine site 620 provides search results 630A-630L. The search engine site further facilitates the user interaction with the search result 630C, a user indication, a cursor (not shown) hovering over search result 630C provides an effective content single pane 610. The user interface herein illustrated is amongst common practice of presenting block previews based on receiving user indication.

Upon receiving the user search query 640 “paris flights” the search engine site 620 provides search results 630A-630L. The search engine site further facilitates the user interaction with the search result 630C, a user indication, a cursor (not shown) hovering over search result 630C provides effective content single pane 610. The effective content single pane 610 can provide the user information associated with the website entity provided by the website entity. The systems and methods herein can be facilitated by the search engine site 620. The information associated can be but is not limited to preview navigation, audio content, video content, multimedia content, partially filled-in purchase orders, purchase orders, subscriptions orders, price quote requests. The search engine site 620, by way of examples can be but are not limited to Google Inc. of Mountain View, Calif., Yahoo Inc. of Sunnyvale, Calif., Bing of Microsoft Corporation of Redmond, Wash. The website entities as used herein refer to any entity presented in a search result space 600 as search results 630A-630L. According to another aspect, the website entities in the form of search results 630A-630L are not limited to entities having an online presence.

FIG. 7 is another illustrated example of a search result space as an electronic marketplace 700 provided by search engine site 720 for monetizing search results 730A-730L as electronic marketplace by way of effective content single pane 710 activated by user indication (not shown) with website entity 740C in the form of search result 730C. The user interface herein illustrated is amongst common practice of presenting block previews based on receiving user indication.

The user indication (not shown) can be explicit actions such as hovering, clicking, information input via keyboard and/or mouse and/or microphone and/or any other input devices of body movement, thought process, gaze direction and similar can be used as input. The user indication can also be implicit actions such as neural networks, expert systems and similar. The search result space 700 can be provided by a search engine site. The search engine site can be a website, a search engine site, an application program, an email service, or any other third party site. The search engine site 720, by way of examples can be but are not limited to search engines by Google Inc. of Mountain View, Calif., Yahoo Inc. of Sunnyvale, Calif., Bing of Microsoft Corporation of Redmond, Wash. The search results 730A-730L can be of any type including but not limited to visual, textual, graphical, photographic, audio, speed, video, multimedia and the like. Website entities 740A-740L as used herein refer to any entity presented in a search result space 700 as search results 730A-730L. According to another aspect, the website entities 740A-740L in the form of search results 730A-730L are not limited to entities having an online presence. Upon receiving the user search query 760 “paris flights” the search engine site 720 provides search results 730A-730L. The search engine site further facilitates the user interaction with the search result 730C, a user indication, a cursor (not shown) hovering over search result 730C provides effective content single pane 710. The effective content single pane 710 can provide the user information associated with the website entity 740C provided by the website entity. The systems and methods herein can be facilitated by the search engine site 720. The information associated can be but is not limited to preview navigation, audio content, video content, multimedia content, partially filled-in purchase orders, purchase orders, subscriptions orders, price quote requests. Illustrated in FIG. 7, the effective content can be an order form 750F allowing the user to purchase a product in a single pane from the website entity 740C within the effective content single pane 710 without leaving the search engine site 720. The effective content single pane 710 provides information such as product detail and pricing 750A-750E provided by the website entity 740C. The order form 750F may be completely or partially filled-in by a user to facilitate the purchase. The buy button 750G can be linked to an online payment system (not shown) facilitated by the search engine site 720. The monetization of search results 730A-730L as an electronic marketplace 700 can also utilize the effective content single pane 710 as opportunities to optimize revenue for it's own online payment system.

By way of example, search engine site 720 can provide tools to large website entities, such as an airline merchant to facilitate the creation of a airline ticket order, the single pane with personalized effective content 710 can allow a user to purchase tickets from the airline merchant. The online payment system facilitated by the search engine site 720 can utilize the opportunity to charge a fee, there by increasing online payment system marketshare.

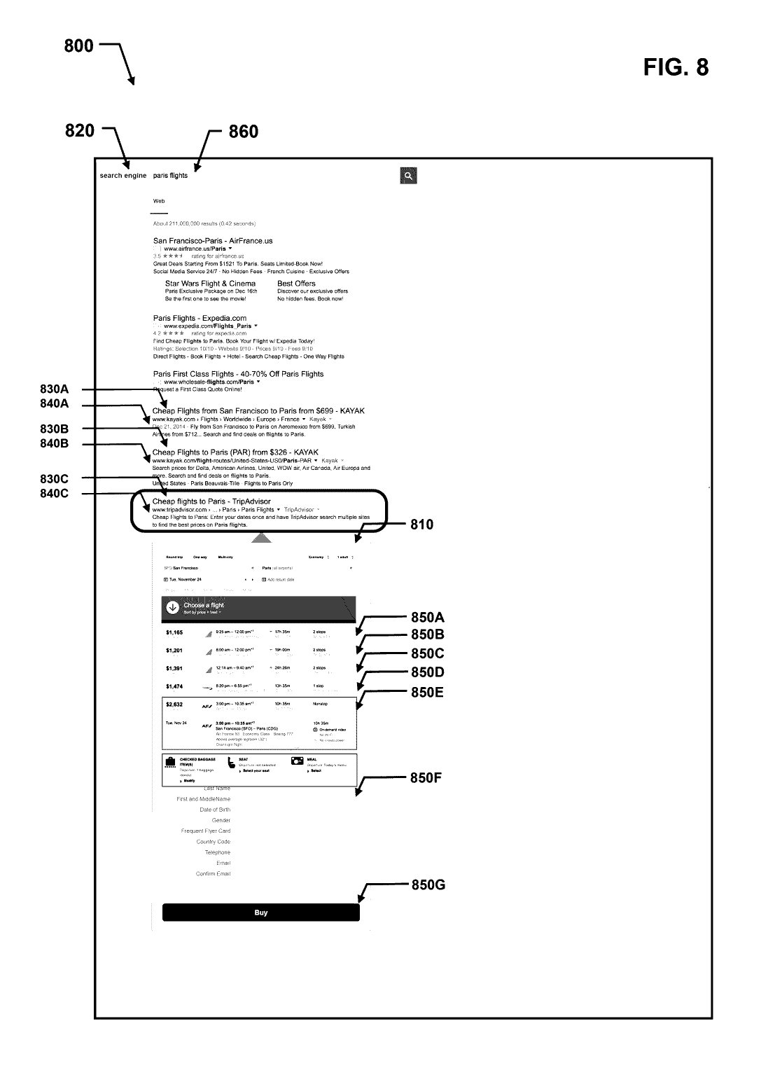

FIG. 8 is another illustrated example of a search result space as an electronic marketplace 800 provided by search engine site 820 for monetizing search results 830A-830C as electronic marketplace by way of effective content single pane 810 activated by user indication (not shown) with website entity 840C in the form of search result 830C. The user interface herein illustrated is amongst common practice of presenting block previews based on receiving user indication.

The user indication (not shown) can be explicit actions such as hovering, clicking, information input via keyboard and/or mouse and/or microphone and/or any other input devices of body movement, thought process, gaze direction and similar can be used as input. The User indication can also be implicit actions such as neural networks, expert systems and similar. The search result space 800 can be provided by a search engine site. The search engine site can be a website, a search engine site, an application program, an email service, or any other third party site. The search engine site 820, by way of examples can be but are not limited to search engines by Google Inc. of Mountain View, Calif., Yahoo Inc. of Sunnyvale, Calif., Bing of Microsoft Corporation of Redmond, Wash. The search results 830A-830C can be of any type including but not limited to visual, textual, graphical, photographic, audio, speed, video, multimedia and the like. Website entities 840A-840C as used herein refer to any entity presented in a search result space 800 as search results 830A-830C. According to another aspect, the website entities 840A-840C in the form of search results 830A-830C are not limited to entities having an online presence. Upon receiving the user search query 860 “paris flights” the search engine site 820 provides search results 830A-830C. The search engine site further facilitates the user interaction with the search result 830C, a user indication, a cursor (not shown) hovering over search result 830C provides effective content single pane 810. The effective content single pane 810 can provide the user information associated with the website entity 840C provided by the website entity. The systems and methods herein can be facilitate by the search engine site 820. The information associated can be but is not limited to preview navigation, audio content, video content, multimedia content, partially filled-in purchase orders, purchase orders, subscriptions orders, price quote requests. Illustrated in FIG. 8, the effective content can be an order form 850F allowing the user to purchase a product in a single pane from the website entity 840C within the effective content single pane 810 without leaving the search engine site 820. The effective content single pane 810 provides information such as product detail and pricing 850A-850E provided by the website entity 840C. The order form 850F may be completely or partially filled-in by a user to facilitate the purchase. The buy button 850G can be linked to an online payment system (not shown) facilitated by the search engine site 820. The monetization of search results 830A-830C as an electronic marketplace 800 can also utilize the effective content single pane 810 as opportunities to optimize revenue for it's own online payment system.

By way of example, search engine site 820 can provide tools to large website entities, such as an airline merchant to facilitate the creation of a airline ticket order, the single pane with personalized effective content 810 can allow a user to purchase tickets from the airline merchant. The online payment system facilitated by the search engine site 820 can utilize the opportunity to charge a fee, there by increasing online payment system marketshare.

1. A method for monetizing search results as an electronic marketplace, comprising:
providing a search result in a search result space, the search result space facilitated by a search engine site;
receiving a usr indication activating a website entity in the form of the search result in the search result space;
providing a single pane having an effective content associated with the website entity in the form of the search result activated by the user indication;
receiving a user input and/or a user purchase;
collecting the user input and/or the user purchase;
determining a fee according to the user input and/or the user purchase; and
charging the website entity in the form of the search result, associated with the effective content the fee based on receiving the user input and/or the user purchase.
